(19) United States
(12) Patent Application Publication
(10) Pub. No.: US 2025/0021887 A1
(43) Pub. Date: Jan. 16, 2025

(54) INFORMATION PROCESSING METHOD, INFORMATION PROCESSING APPARATUS, AND PROGRAM

(71) Applicant: FUJIFILM Corporation, Tokyo (JP)

(72) Inventors: Masahiro SATO, Tokyo (JP); Tomoki TANIGUCHI, Tokyo (JP); Tomoko OHKUMA, Tokyo (JP)

(73) Assignee: FUJIFILM Corporation, Tokyo (JP)

(21) Appl. No.: 18/896,910

(22) Filed: Sep. 26, 2024

Related U.S. Application Data
(63) Continuation of application No. PCT/JP2023/010627, filed on Mar. 17, 2023.

(30) Foreign Application Priority Data
Mar. 28, 2022 (JP) 2022-052101

(51) Int. Cl. G06N 20/00

(52) U.S. Cl. CPC G06N 20/00

(57) ABSTRACT

Provided are an information processing method, an information processing apparatus, and a program that realize generation of a dataset of a user behavior history of different domains. An information processing method includes acquiring a dataset in one domain, the dataset being a dataset in which the response variable, the explanatory variable, and a plurality of variables excluding the response variable and the explanatory variable are applied, selecting a plurality of domain candidate variables that are domain candidates from the plurality of variables excluding the response variable and the explanatory variable, generating a dataset candidate that divides the dataset by using the domain candidate variables, and generating, in a case where each of the dataset candidates is a dataset in a different domain, a divided dataset by setting the domain candidate variables as domains.

### CROSS-REFERENCE TO RELATED APPLICATIONS

The present application is a Continuation of PCT International Application No. PCT/JP2023/010627 filed on Mar. 17, 2023 claiming priority under 35 U.S.C § 119 (a) to Japanese Patent Application No. 2022-052101 filed on Mar. 28, 2022. Each of the above applications is hereby expressly incorporated by reference, in its entirety, into the present application.

### BACKGROUND OF THE INVENTION

### 1. Field of the Invention

The present invention relates to an information processing method, an information processing apparatus, and a program.

### 2. Description of the Related Art

It is difficult for a user to select the best item that suits him/herself from many items in terms of time and cognitive ability. For example, in the case of a user of the EC site, the item is a product handled by the EC site, and in the case of a user of a document information management system, the item is the stored document information.

Dietmar Jannach, Markus Zanker, Alexander Felfernig, Gerhard Friedrich, translated by Katsumi Tanaka, Kazutoshi Kakutani “Introduction to Information Suggestion System-Theory and Practice-” Kyoritsu Publishing Co., Ltd., 2012 and Deepak K. Agarwal, Bee-Chung Chen, “Suggestion System: Theory and Practice of Statistical Machine Learning,” Kyoritsu Publishing Co., Ltd., 2018 discloses research related to an information suggestion technique, which is a technique for presenting a selection candidate from among items for the purpose of assisting selection of a user. The EC of the EC site is an abbreviation for electronic commerce.

Generally, an information suggestion system performs a training based on data collected at an introduction destination facility. However, in a case where the information suggestion system is introduced into a facility different from the training data, there is a problem in that the prediction accuracy of the model is reduced. The problem that a machine learning model does not work well at unknown other facilities is called domain shift, and research related to domain generalization, which is research on improving robustness against the domain shift, has been active in recent years, mainly in image recognition as described in Jindong Wang1, Cuiling Lan1, Chang Liu1, Yidong Ouyang2, and Tao Qin, “Generalizing to Unseen Domains: A Survey on Domain Generalization” Microsoft Research, Beijing, China, 2021 and Kaiyang Zhou, Ziwei Liu, Yu Qiao, Tao Xiang, and Chen Change Loy “Domain Generalization in Vision: A Survey” Central University of Finance and Economics, Beijing, China, 2021.

In the learning and evaluation of domain generalization, a plurality of domain datasets are essential, and the number of domains is preferably large. Since it is often difficult or costly to collect a large amount of data in many domains, a technique for generating data in different domains is required.

WANG Qinyong, YIN Hongzhi, WANG Hao, NGUYEN Quoc Viet Hung, HUANG Zi, CUI Lizhen “Enhancing Collaborative Filtering with Generative Augmentation” Griffith University, 2019 discloses a technique of generating a user behavior history required for an information suggestion technique in a pseudo manner using a conditional generative adversarial network (CGAN) which is one of data generation methods using deep learning.

Kaiyang Zhou, Yongxin Yang, Timothy Hospedales, and Tao Xiang, “Learning to Generate Novel Domains for Domain Generalization”, 2020 discloses a technique for generating data of different domains. Specifically, the same document proposes a generator that converts data of a source domain into data of different pseudo domains. The generator described in the same document generates a pseudo domain in which a distance of a probability distribution of data from a source domain is increased.

JP2021-197181A discloses a multi-model provision method that divides users into a plurality of groups, applies federated learning to each group, and generates a prediction model to be applied to a service as a multi-model.

JP2016-062509A discloses an information processing apparatus that groups users using a user attribute and a Dirichlet process, and generates a prediction model for each group. The apparatus disclosed in the same document selects a prediction model suitable for a user from the generated prediction models.

JP2021-086558A discloses a medical diagnosis apparatus that sorts out training data of AI for medical facilities on the basis of attribute information or the like. The apparatus disclosed in the same document performs sorting in which the bias of the attribute is reduced and sorting in which the test data of the facility using the trained AI and the attribute distribution are close to each other. AI is an abbreviation for artificial intelligence.

### SUMMARY OF THE INVENTION

However, in much of the related art, it is assumed that there is data for each of a plurality of domains that can be used for learning and evaluation of a model, and it is difficult to perform learning and evaluation in a case where there is only data for a single domain. Even in a case where there is data for each of the plurality of domains, in a case where the number of domains is not a sufficient number for learning and evaluation, the performance of the learning model is deteriorated.

As described in Wang, Qinyong, Yin, Hongzhi, Wang, Hao, Nguyen, Quoc Vict Hung, Huang, Zi, Cui, and Lizhen “Enhancing Collaborative Filtering with Generative Augmentation” Griffith University”, 2019, there is a study on generating a behavior history of a user, but the study generates data of the same domain and does not generate data of a plurality of domains from data of a single domain.

As described in Kaiyang Zhou, Yongxin Yang, Timothy Hospedales, and Tao Xiang, “Learning to Generate Novel Domains for Domain Generalization”, 2020, in a case where there are not a sufficient number of domains for learning and evaluation, an attempt to generate data of different domains from data of a single domain has been started, but sufficient results have not been obtained.

The method disclosed in JP2021-197181A is interpreted to be intended to classify the users having similar characteristics into the groups for each user, based on the description in a paragraph [0064] and the description in a paragraph [0066]. In a case where data of a single domain is divided into data of a plurality of domains, the difference between the groups is important, and in the method described in the same document, it is difficult to appropriately divide the domains.

The apparatus disclosed in JP2016-062509A performs grouping for the purpose of reducing the number of explanatory variables required for the prediction model and shortening the calculation time of the predicted value, and classifies the users having similar characteristics into groups for each user in the same manner as the method disclosed in JP2021-197181A. On the other hand, in the domain division, the difference between the groups is important rather than the similarity of the data in the group, and it is difficult to perform appropriate domain division in the apparatus described in the same document.

The apparatus disclosed in JP2021-086558A is considered to be intended for developing domain-specialized AI instead of generalization of domains from the description in paragraph [002] and the description in paragraph of the same document. The apparatus disclosed in the same document performs selection of data aiming at constructing a model suitable for a single domain, and it is difficult to construct a model of domain generalization only with the selected data. In addition, the apparatus disclosed in the same document generates a single dataset, and it is difficult to generate a plurality of datasets.

The present invention has been made in view of such circumstances, and an object of the present invention is to provide an information processing method, information processing apparatus, and a program that realize generation of a dataset of a user behavior history of different domains.

According to the present disclosure, there is provided an information processing method of generating a dataset applied to construction of a prediction model using a response variable and one or more explanatory variables, with user behavior as the response variable, for a dataset consisting of a behavior history with respect to a plurality of items of a plurality of the users, the information processing method including: acquiring a dataset in one domain, the dataset being a dataset in which the response variable, the explanatory variable, and a plurality of variables excluding the response variable and the explanatory variable are applied; selecting a plurality of domain candidate variables that are domain candidates from the plurality of variables excluding the response variable and the explanatory variable; generating a dataset candidate that divides the dataset by using the domain candidate variables; determining whether or not each dataset candidate is a dataset in different domains; and generating, in a case where each dataset candidate is a dataset in different domains, a divided dataset by dividing the dataset for each of domains using the domain candidate variables as domains.

According to the information processing method according to the aspect of the present disclosure, it is possible to generate a dataset of a pseudo different domain from a dataset in one domain.

In the information processing method according to still another aspect, the dataset candidate with which at least a part of a distribution of an existence probability of data for each of the explanatory variables overlaps may be generated.

According to such an aspect, a plurality of datasets in which the explanatory variables overlap with each other are generated.

In the information processing method according to still another aspect, time may be applied as the domain candidate variable to generate the dataset candidate.

According to such an aspect, it is possible to generate a dataset of pseudo different domains in which a difference in time series is set as a difference in domains.

In the information processing method according to another aspect, a user attribute, which is not applied to the explanatory variable, may be applied as the domain candidate variable to generate the dataset candidate.

According to such an aspect, it is possible to generate a dataset of a pseudo different domain in which the difference in the user attribute is set as the difference in the domain.

In the information processing method according to another aspect, an item attribute, which is not applied to the explanatory variable, may be applied as the domain candidate variable to generate the dataset candidate.

According to such an aspect, it is possible to generate a dataset of a pseudo different domain in which the difference in the item attribute is set as the difference in the domain.

In the information processing method according to another aspect, a context, which is not applied to the explanatory variable, may be applied as the domain candidate variable to generate the dataset candidate.

According to such an aspect, it is possible to generate a dataset of a pseudo different domain in which a difference in the context is set as a difference in the domain.

In the information processing method according to still another aspect, whether or not the dataset candidate is a dataset in a different domain may be determined based on one or more differences in probability distribution between the explanatory variables and the response variables.

In the information processing method according to still another aspect, a trained model generated being trained using any of a plurality of the dataset candidates may be generated, among the plurality of dataset candidates, performance of the trained model may be evaluated in a range of a first dataset candidate, performance of the trained model may be evaluated in a range of a second dataset candidate different from the first dataset candidate, and whether or not the dataset candidates are in different domains may be determined based on a performance difference between performance of the trained model corresponding to the first dataset candidate and performance of the trained model corresponding to the second dataset candidate.

According to such an aspect, it is possible to determine whether or not the dataset is in different domains based on the difference in performance of the learning model corresponding to each of the domain candidate variables.

In the information processing method according to still another aspect, processing of causing each user or each item to exist in only one of the divided datasets may be performed on the divided dataset.

According to such an aspect, it is possible to perform learning and evaluation of a trained model with respect to a relatively large domain shift at a system level.

According to the present disclosure, there is provided an information processing apparatus that generates a dataset applied to construction of a prediction model using a response variable and one or more explanatory variables, with user behavior as the response variable, for a dataset consisting of a behavior history with respect to a plurality of items of a plurality of the users, the information processing apparatus including: one or more processors; and one or more memories in which a program executed by the one or more processors is stored, in which the one or more processors are configured to execute a command of the program to: acquire a dataset in one domain, the dataset being a dataset in which the response variable, the explanatory variable, and a plurality of variables excluding the response variable and the explanatory variable are applied; select a plurality of domain candidate variables that are domain candidates from the plurality of variables excluding the response variable and the explanatory variable; generate a dataset candidate that divides the dataset by using the domain candidate variables; determine whether or not each dataset candidate is a dataset in different domains; and in a case where each dataset candidate is a dataset in different domains, generate a divided dataset by dividing the dataset for each of domains using the domain candidate variables as domains.

According to the information processing apparatus according to the present disclosure, it is possible to obtain the same operation and effect as those of the information processing method according to the present disclosure. Configuration requirements of the information processing method according to still another aspect can be applied to configuration requirements of an information processing apparatus according to still another aspect.

According to the present disclosure, there is provided a program for generating a dataset applied to construction of a prediction model using a response variable and one or more explanatory variables, with user behavior as the response variable, for a dataset consisting of a behavior history with respect to a plurality of items of a plurality of the users, the program causing a computer to implement: a function of acquiring a dataset in one domain, the dataset being a dataset in which the response variable, the explanatory variable, and a plurality of variables excluding the response variable and the explanatory variable are applied; a function of selecting a plurality of domain candidate variables that are domain candidates from the plurality of variables excluding the response variable and the explanatory variable; a function of generating a dataset candidate that divides the dataset by using the domain candidate variables; determine whether or not each dataset candidate is a dataset in different domains; and a function of generating, in a case where each dataset candidate is a dataset in different domains, a divided dataset by dividing the dataset for each of domains using the domain candidate variables as domains.

According to the program according to the present disclosure, it is possible to obtain the same operation and effect as those of the information processing method according to the present disclosure. Configuration requirements of an information processing method according to still another aspect can be applied to configuration requirements of a program according to still another aspect.

According to the present invention, it is possible to generate a dataset of a pseudo different domain from a dataset in one domain.

### BRIEF DESCRIPTION OF THE DRAWINGS

FIG. 1 is a conceptual diagram of a typical suggestion system.

FIG. 2 is a conceptual diagram showing an example of machine learning with a teacher that is widely used in construction of a suggestion system.

FIG. 3 is an explanatory diagram showing a typical introduction flow of the suggestion system.

FIG. 4 is an explanatory diagram of an introduction process of the suggestion system in a case where data of an introduction destination facility cannot be obtained.

FIG. 5 is an explanatory diagram in a case where a model is trained by domain adaptation.

FIG. 6 is an explanatory diagram of an introduction flow of the suggestion system including a step of evaluating performance of the trained learning model.

FIG. 7 is an explanatory diagram showing an example of training data and evaluation data used for the machine learning.

FIG. 8 is a graph schematically showing a difference in performance of a model due to a difference in a dataset.

FIG. 9 is an explanatory diagram of data necessary for developing a domain generalization model.

FIG. 10 is a block diagram schematically showing an example of a hardware configuration of an information processing apparatus according to an embodiment.

FIG. 11 is a functional block diagram showing a functional configuration of the information processing apparatus shown in FIG. 10.

FIG. 12 is a flowchart showing a procedure of an information processing method according to the embodiment.

FIG. 13 is a schematic diagram of generation of a dataset using a domain candidate variable.

FIG. 14 is a schematic diagram showing an example of domain division candidate case generation applied to the generation of the dataset shown in FIG. 13.

FIG. 15 is a schematic diagram showing another example of domain division candidate case generation applied to the generation of the dataset shown in FIG. 13.

FIG. 16 is a schematic diagram of generation of a dataset in a case where a plurality of domain candidate variables are selected.

FIG. 17 is a schematic diagram showing an example of generation of a domain division candidate case.

FIG. 18 is a schematic diagram showing another example of the generation of the domain division candidate case.

FIG. 19 is a schematic diagram showing generation of domain division candidate cases in a case where the explanatory variables are different from the explanatory variables shown in FIG. 17.

FIG. 20 is a schematic diagram showing generation of domain division candidate cases in a case where the explanatory variables are different from the explanatory variables shown in FIG. 18.

FIG. 21 is a schematic diagram of generation of a domain division candidate case to which time is applied as a domain candidate variable.

FIG. 22 is a schematic diagram of generation of a domain division candidate case to which a user attribute is applied as a domain candidate variable.

FIG. 23 is a table showing an example of a dataset shown in FIG. 22.

FIG. 24 is a schematic diagram showing a specific example of the determination of different domains.

### DESCRIPTION OF THE PREFERRED EMBODIMENTS

Hereinafter, preferred embodiments of the present invention will be described in detail with reference to the accompanying drawings. In the present specification, the same components are denoted by the same reference numerals, and duplicate description thereof will be omitted as appropriate.

### Overview of Information Suggestion Technique

In the present embodiment, a method of generating data of different domains related to user behavior history data used for training and an evaluation of a model used in a suggestion system will be described. First, the outline of an information suggestion technique and the necessity of data of a plurality of domains will be overviewed by showing specific examples. The information suggestion technique is a technique for suggesting an item to a user.

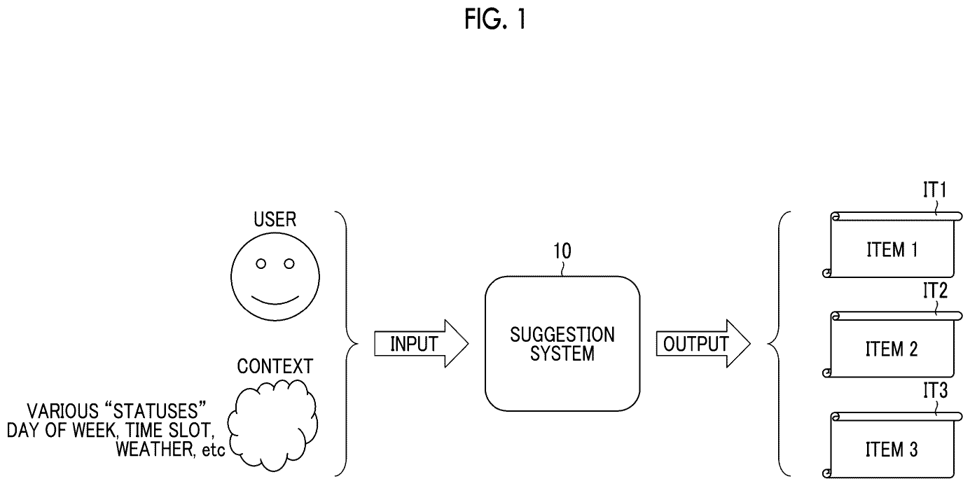

FIG. 1 is a conceptual diagram of a typical suggestion system. The suggestion system 10 receives user information and context information as inputs and outputs information of the item that is suggested to the user according to a context. The context means various statuses and may be, for example, a day of the week, a time slot, or the weather. The items may be various objects such as a book, a video, a restaurant, and the like.

The suggestion system 10 generally suggests a plurality of items at the same time. FIG. 1 shows an example in which a suggestion system 10 suggests three items of an item IT1, an item IT2, and an item IT3. In a case where the user responds positively to the suggested item IT1, item IT2, and item IT3, the suggestion is generally considered to be successful. A positive response is, for example, a purchase, browsing, and visit. Such a suggestion technique is widely used, for example, in an EC site, a gourmet site that introduces a restaurant, or the like.

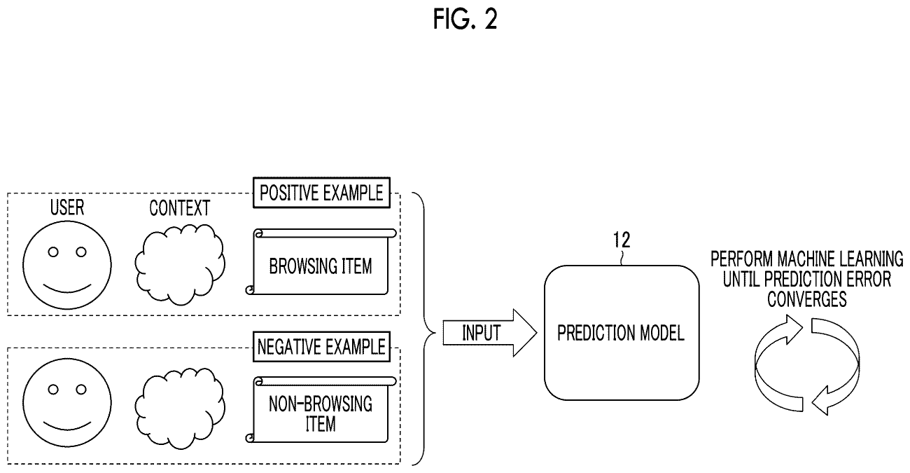

FIG. 2 is a conceptual diagram showing an example of machine learning with a teacher that is widely used in construction of a suggestion system. The suggestion system 10 is constructed by using a machine learning technique. Generally, a positive example and a negative example are prepared based on a user behavior history in the past, a combination of the user and the context is input to a prediction model 12, and the prediction model 12 is trained such that a prediction error becomes small. For example, a browsed item that is browsed by the user is defined as a positive example, and a non-browsed item that is not browsed by the user is defined as a negative example. The machine learning is performed until the prediction error converges, and the target prediction performance is acquired.

By using the trained prediction model 12, which is trained in this way, items with a high browsing probability, which is predicted with respect to the combination of the user and the context, are suggested. The trained prediction model 12 is synonymous with the trained-ended prediction model 12.

For example, in a case where a combination of a certain user A and a context β is input to the trained prediction model 12, the prediction model 12 infers that the user A has a high probability of browsing a document such as the item IT3 shown in FIG. 1 under a condition of the context β and suggests an item similar to the item IT3 to the user A. Depending on the configuration of the suggestion system 10, items are often suggested to the user without considering the context.

### [Example of Data Used for Developing Suggestion System]

The user behavior history is equivalent to correct answer data in machine learning. Strictly speaking, it is understood as a task setting of inferring the next behavior from the past behavior history, but it is general to train the potential feature amount based on the past behavior history.

The user behavior history may include, for example, a book purchase history, a video viewing history, or a restaurant visit history.

Further, main feature amounts include a user attribute and an item attribute. The user attribute may have various elements such as, for example, gender, age group, occupation, family structure, and residential area. The item attribute may have various elements such as a book genre, a price, a video genre, a length, a restaurant genre, and a place.

### [Model Construction and Operation]

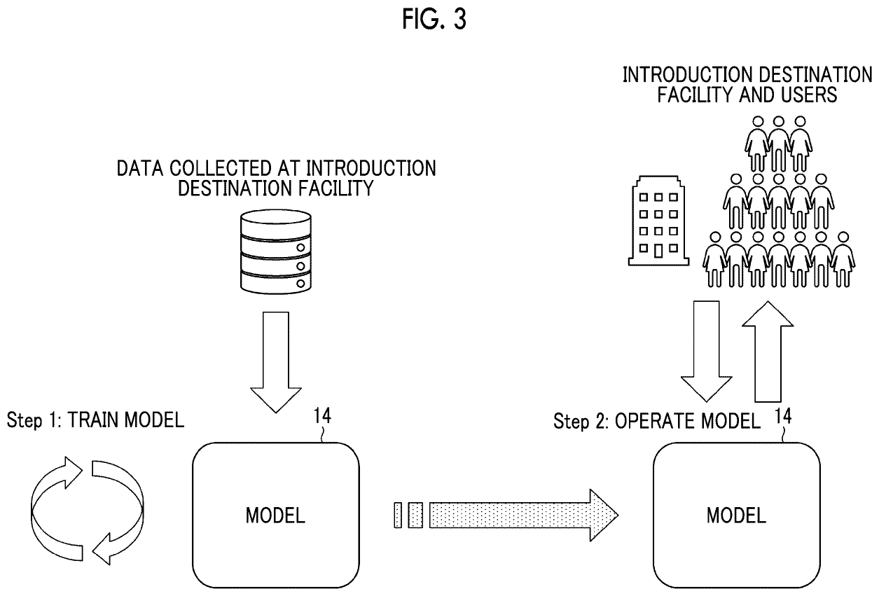

FIG. 3 is an explanatory diagram showing a typical introduction flow of the suggestion system. Here, a typical flow in a case where the suggestion system is introduced to a certain facility, is shown. The introduction of the suggestion system constructs a model 14 for performing a target suggestion task as Step 1, and then introduces and operates the constructed model 14 as Step 2.

In the case of a machine learning model, the construction of the model 14 includes training the model 14 by using training data to create a suggestion model, which is a prediction model that satisfies a practical level of suggestion performance. The operation of the model 14 is, for example, obtaining an output of a suggested item list from the trained model 14 with respect to the input of the combination of the user and the context.

Training data is required for construction of the model 14. As shown in FIG. 3, in general, the model 14 of the suggestion system is trained based on the data collected at an introduction destination facility. By performing training by using the data collected from the introduction destination facility, the model 14 learns the behavior of the user in the introduction destination facility and can accurately predict suggestion items for the user in the introduction destination facility.

However, due to various circumstances, it may not be possible to obtain data on the introduction destination facility. For example, in the case of a document information suggestion system in an in-house system of a company or a document information suggestion system in an in-hospital system of a hospital, a company that develops a suggestion model may not be able to access the data of the introduction destination facility. In a case where the data of the introduction destination facility cannot be obtained, instead, it is necessary to perform training based on data collected at different facilities.

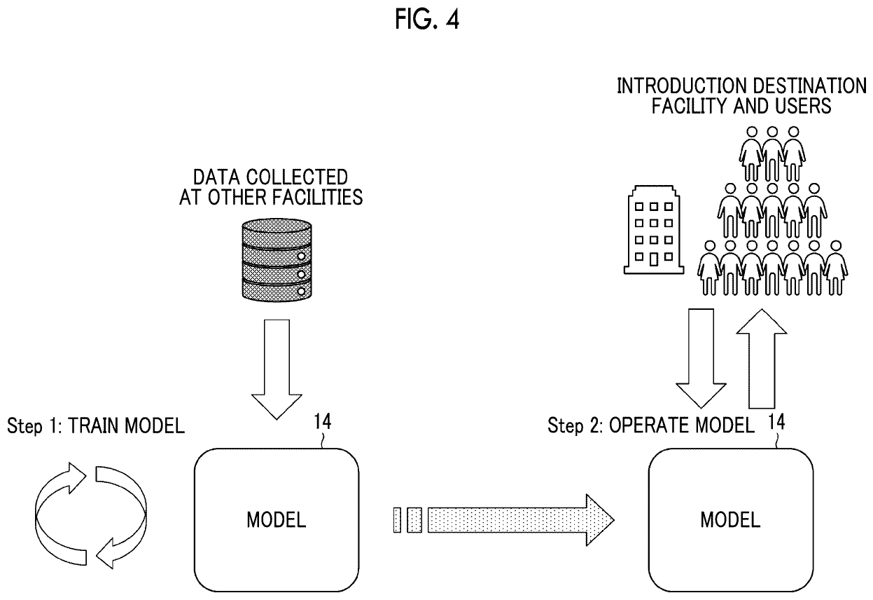

FIG. 4 is an explanatory diagram of an introduction process of the suggestion system in a case where data of an introduction destination facility cannot be obtained. In a case where the model 14, which is trained by using the data collected at a facility different from the introduction destination facility, is operated in the introduction destination facility, there is a problem that the prediction accuracy of the model 14 decreases due to differences in user behavior between facilities.

The problem that the machine learning model does not work well in unknown facilities different from the trained facility is understood as a technical problem, in a broad sense, to improve robustness against a problem of domain shift in which a source domain where the model 14 is trained differs from a target domain where the model 14 is applied. There is domain adaptation as problem settings related to domain generalization. This is a method of training by using data from both the source domain and the target domain. The purpose of using the data of different domains in spite of the presence of the data of the target domain is to make up for the fact that the amount of data of the target domain is small and insufficient for training.

Note that, “domain generalization” can be referred to as domain generalization using English notation. “domain generalization” can be referred to as domain adaptation using English notation.

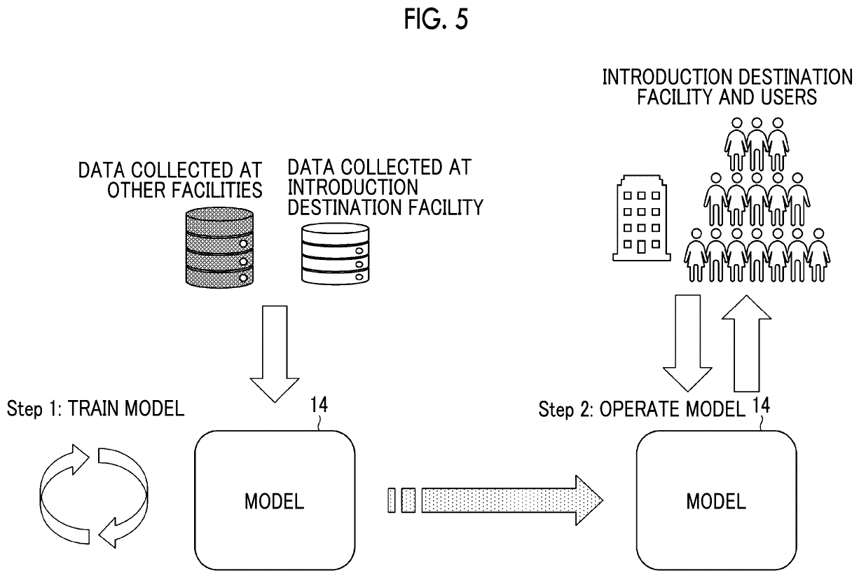

FIG. 5 is an explanatory diagram in a case where a model is trained by domain adaptation. Although the amount of data collected at the introduction destination facility that is the target domain is relatively smaller than the data collected at a different facility, the model 14 can also predict with a certain degree of accuracy the behavior of the users in the introduction destination facility by performing a training by using both data.

### [Description of Domain]

The above-mentioned difference in a facility is a kind of difference in a domain. In Ivan Cantador et al, Chapter 27: “Cross-domain Recommender System”, which is a document related to research on domain adaptation in information suggestion, differences in domains are classified into the following four categories.

### [Item Attribute Level]

For example, a comedy movie and a horror movie are in different domains. Note that, “item attribute level” may be referred to as an item attribute level using English notation.

### [Item Type Level]

For example, a movie and a TV drama series are in different domains. Note that, “item type level” may be referred to as an item type level using English notation.

### [Item Level]

For example, a movie and a book are in different domains. Note that, “item level” may be referred to as an item level using English notation.

### [System Level]

For example, a movie in a movie theater and a movie broadcast on television are in different domains. Note that, “system level” may be referred to as a system level using English notation.

The difference in facility shown in FIG. 5 or the like corresponds to the domain of the system level in the above four categories.

In a case where a domain is formally defined, the domain is defined by a simultaneous probability distribution P(X,Y) of a response variable Y and an explanatory variable X, and in a case where Pd1(X,Y) #Pd2(X,Y), d1 and d2 are different domains.

The simultaneous probability distribution P(X,Y) can be represented by a product of an explanatory variable distribution P(X) and a conditional probability distribution P(Y|X) or a product of a response variable distribution P(Y) and a conditional probability distribution P(Y|X).

$$P ( X , Y ) = P ( Y \vert X ) P ( X ) = P ( X \vert Y ) P ( Y )$$

Therefore, in a case where one or more of P(X), P(Y), P(Y|X), and P(X|Y) is changed, the domains become different from each other.

### [Typical Pattern of Domain Shift]

### [Covariate Shift]

In a case where the distributions P(X) of the explanatory variables are different, it is called a covariate shift. For example, a case where distributions of user attributes are different between datasets, more specifically, a case where a gender ratio is different, and the like correspond to the covariate shift. Note that, “covariate shift” may be referred to as a covariate shift using English notation.

### [Prior Probability Shift]

In a case where the distributions P(Y) of the response variables are different, it is called a prior probability shift. For example, a case where an average browsing rate or an average purchase rate differs between datasets corresponds to the prior probability shift. Note that, “prior probability shift” may be referred to as a prior probability shift using English notation.

### [Concept Shift]

A case where conditional probability distributions P(Y|X) and P(X|Y) are different is called a concept shift. For example, a probability that a research and development department of a certain company reads data analysis materials is assumed as P(Y|X), and in a case where the probability differs between datasets, this case corresponds to the concept shift. Note that, “concept shift” may be referred to as a concept shift using English notation.

Research on domain adaptation or domain generalization includes assuming one of the above-mentioned patterns as a main factor and looking at dealing with P(X,Y) changing without specifically considering which pattern is a main factor. In the former case, there are many cases in which a covariate shift is assumed.

### [Reason for Influence of Domain Shift]

A prediction classification model that performs a prediction or classification task makes inferences based on a relationship between the explanatory variable X and the response variable, thereby in a case where P(Y|X) is changed, naturally at least one of the prediction performance or classification performance is decreased. Further, although minimization of at least one of a prediction error or a classification error is performed within training data in a case where machine learning is performed on the prediction classification model, for example, in a case where the frequency in which the explanatory variable becomes X=X_1 is greater than the frequency in which the explanatory variable becomes X=X_2, that is, in a case where P(X=X_1)>P(X=X_2), since the data of X=X_1 is more than the data of X=X_2, error decrease for X=X_1 is trained in preference to error decrease for X=X_2. Therefore, even in a case where P(X) is changed between the facilities, at least one of the prediction error or the classification error is reduced.

The domain shift can be a problem not only for information suggestions but also for various task models. For example, regarding a model that predicts the retirement risk of an employee, a domain shift may become a problem in a case where a prediction model, which is trained by using data of a certain company, is operated by another company. Further, in a model that predicts an antibody production amount of a cell, a domain shift may become a problem in a case where a model, which is trained by using data of a certain antibody, is used for another antibody. Further, for a model that classifies the voice of customer, for example, a model that classifies VOC into a product function, a support handling, and others, a domain shift may be a problem in a case where a classification model, which is trained by using data related to a certain product, is used for another product. Further, VOC is an abbreviation for voice of customer, which is an English notation of “voice of customer”.

[Regarding Evaluation before Introduction of Model]

In many cases, a performance evaluation is performed on the model 14 before the trained model 14 is introduced into an actual facility or the like. The performance evaluation is necessary for determining whether or not to introduce the model and for research and development of models or learning methods.

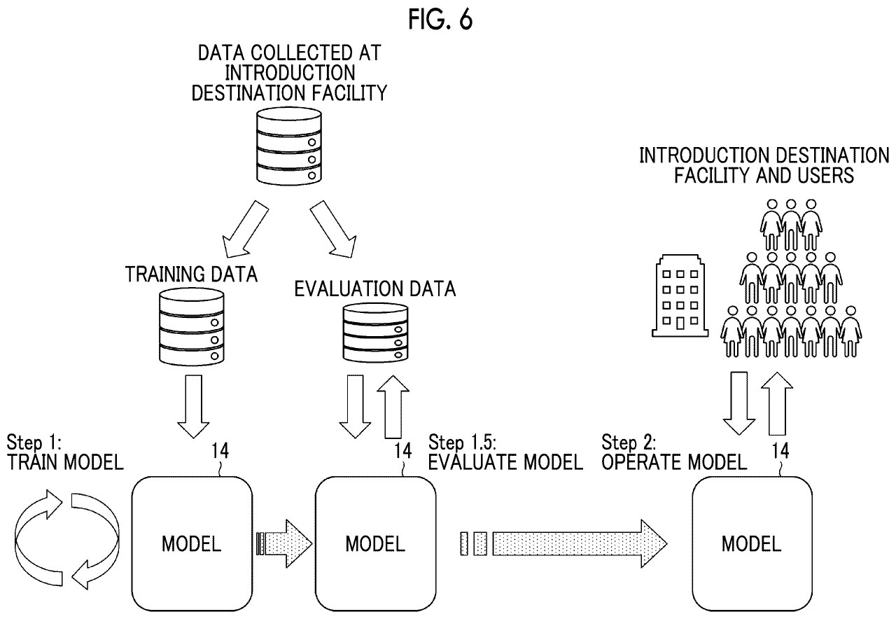

FIG. 6 is an explanatory diagram of an introduction flow of the suggestion system including a step of evaluating the performance of the trained learning model. In FIG. 6, a step of evaluating the performance of the model 14 is added as Step 1.5 between Step 1 of training the model 14 and Step 2 of operating the model 14 described in FIG. 5. Other configurations are the same as in FIG. 5.

As shown in FIG. 6, in a general introduction flow of the suggestion system, the data, which is collected at the introduction destination facility, is often divided into training data and evaluation data. The prediction performance of the model 14 is checked by using the evaluation data, and then the operation of the model 14 is started.

However, in a case of constructing the domain generalization model 14, the training data and the evaluation data need to be different domains. Further, in the domain generalization, it is preferable to use the data of a plurality of domains as the training data, and it is more preferable that there are many domains that can be used for training.

### Regarding Generalization

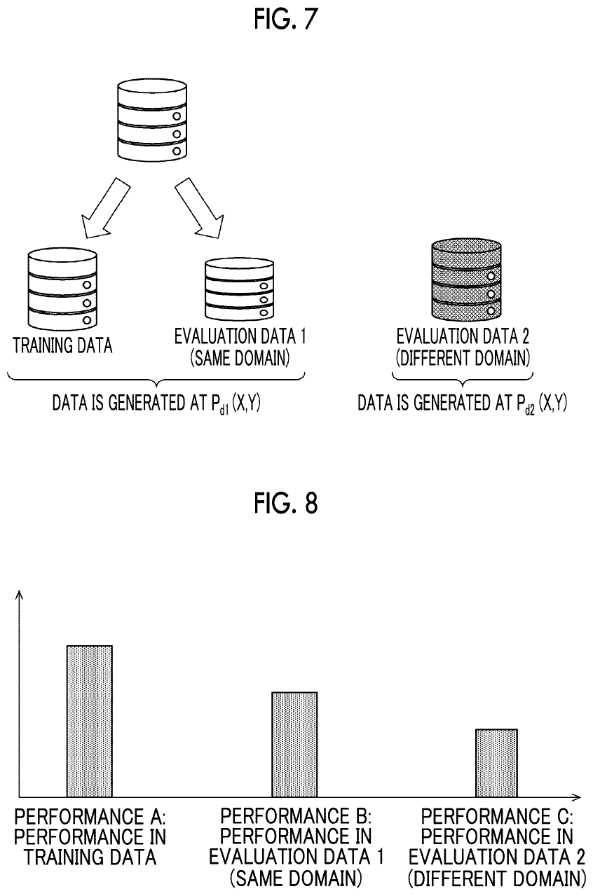

FIG. 7 is an explanatory diagram showing an example of training data and evaluation data used for the machine learning. The dataset obtained from the simultaneous probability distribution Pd1(X,Y) of a certain domain d1 is divided into training data and evaluation data. The evaluation data of the same domain as the training data is referred to as first evaluation data and is referred to as evaluation data 1 in FIG. 7. Further, a dataset, which is obtained from a simultaneous probability distribution Pd2(X,Y) of a domain d2 different from the domain d1, is prepared and is used as the evaluation data. The evaluation data of the different domain with the training data is referred to as second evaluation data and is referred to as evaluation data 2 in FIG. 7.

The model 14 is trained by using the training data of the domain d1, and the performance of the model 14, which is trained by using each of the first evaluation data of the domain d1 and the second evaluation data of the domain d2, is evaluated.

FIG. 8 is a graph schematically showing a difference in performance of a model due to a difference in a dataset. In a case where the performance of the model 14 in the training data is defined as performance A, the performance of the model 14 in the first evaluation data is defined as performance B, and the performance of the model 14 in the second evaluation data is defined as performance C, normally, a relationship is represented such that performance A>performance B>performance C, as shown in FIG. 8.

High generalization performance of the model 14 generally indicates that the performance B is high, or indicates that a difference between the performances A and B is small. That is, the high generalization performance of the model 14 aims at high prediction performance even for unlearned data without over-fitting to the training data.

In the context of domain generalization in the present specification, it means that the performance C is high or a difference between the performance B and the performance C is small. In other words, the aim is to achieve high performance consistently even in a domain different from the domain used for the training.

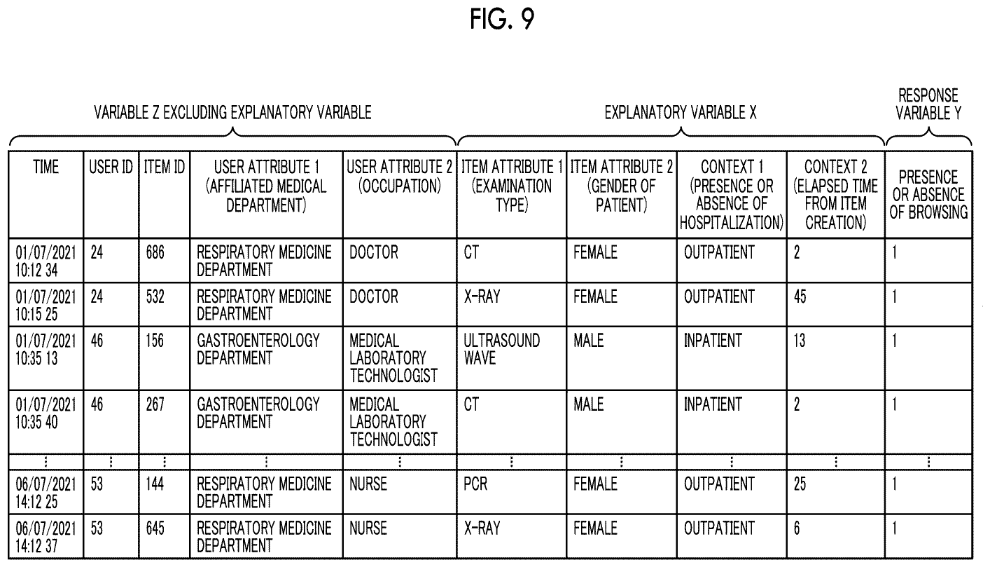

FIG. 9 is an explanatory diagram of data necessary for developing a domain generalization model. In order to develop the domain generalization model 14, as shown in FIG. 9, it is preferable to prepare data collected at a plurality of different facilities, use a dataset of a plurality of domains as training data, and use a dataset of domains further different from the plurality of domains as evaluation data.

### Problems

As described above, in order to develop a model having a robust performance in a plurality of facilities, basically, data of a plurality of facilities is required. However, in reality, it is often difficult to prepare data of a plurality of different facilities. It is desired to realize a model having domain generalization even in a case where the number of domains that can be utilized for training or evaluation of the model is small or even in a case where there is only one piece of data of one domain. In the present embodiment, even in a case where there is only data of one domain, a method of generating data of other domains in a pseudo method is provided.

### Configuration Example of Information Processing Apparatus According to Embodiment

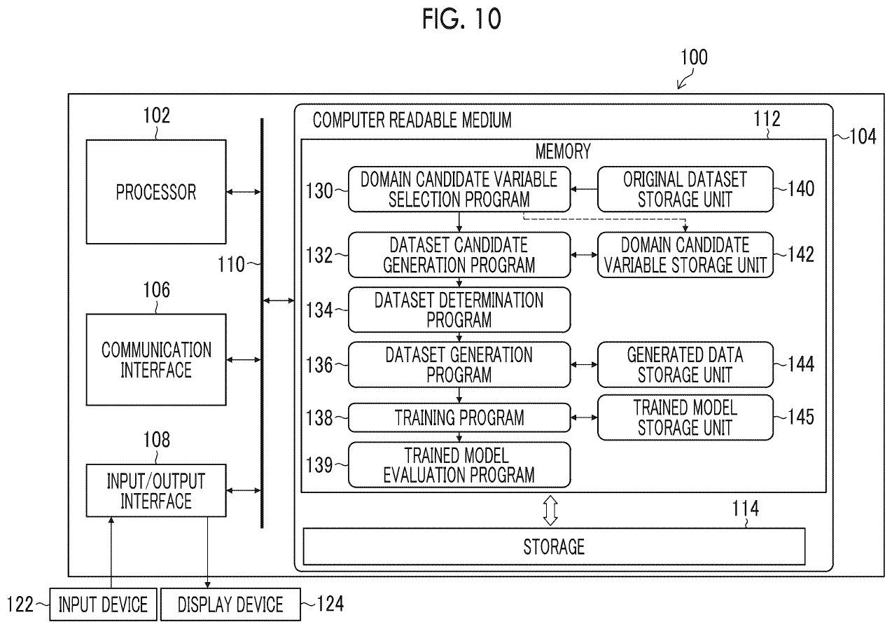

FIG. 10 is a block diagram schematically showing an example of a hardware configuration of an information processing apparatus according to the embodiment. The information processing apparatus 100 generates a dataset for each domain by executing processing of dividing a dataset consisting of behavior histories for a plurality of items of a plurality of users into domains with a plurality of variables excluding the response variable and the explanatory variable.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input/output interface 108, and a bus 110.

The processor 102 includes a central processing unit (CPU). The processor 102 may include a graphics processing unit (GPU). The processor 102 is connected to the computer-readable medium 104, the communication interface 106, and the input/output interface 108 via the bus 110.

The processor 102 reads out various programs, data, and the like stored in the computer-readable medium 104 and executes various processes. The term program includes the concept of a program module and includes commands conforming to the program.

The computer-readable medium 104 is, for example, a storage device including a memory 112 which is a main memory and a storage 114 which is an auxiliary storage device. The storage 114 is configured by using, for example, a hard disk device, a solid state drive device, an optical disk, a photomagnetic disk, a semiconductor memory, or the like. The storage 114 may be configured by using an appropriate combination of the above-described devices. Various programs, data, and the like are stored in the storage 114.

Note that, “hard disk device” may be referred to as an HDD, which is an abbreviation for hard disk drive using English notation. “Solid state drive” may be referred to as an SSD, which is an abbreviation for solid state drive using English notation.

The memory 112 includes an area used as a work area of the processor 102 and an area for temporarily storing a program read from the storage 114 and various types of data. By loading the program that is stored in the storage 114 into the memory 112 and executing commands of the program by the processor 102, the processor 102 functions as a unit for performing various processes defined by the program.

The memory 112 stores various programs, such as a domain candidate variable selection program 130, a dataset candidate generation program 132, a dataset determination program 134, a dataset generation program 136, a learning program 138, and a trained model evaluation program 139, which are executed by using the processor 102, various data, and the like.

The memory 112 includes an original dataset storage unit 140, a domain candidate variable storage unit 142, a generated data storage unit 144, and a trained model storage unit 145. The original dataset storage unit 140 is a storage region in which a dataset that is a basis for generating a dataset of a different domain is stored as the original dataset.

The domain candidate variable storage unit 142 is a storage region in which a plurality of variables excluding the response variable and the explanatory variable are stored as a domain. The generated data storage unit 144 is a storage region in which the data of the pseudo behavior history generated by using the dataset generation program 136 is stored.

The trained model storage unit 145 is a storage region in which learning is performed using a dataset generated as a dataset of different domains and in which the generated trained model is stored.

The communication interface 106 performs a communication process with an external device by wire or wirelessly and exchanges information with the external device. The information processing apparatus 100 is connected to a communication line via the communication interface 106.

The communication line may be a local area network, a wide area network, or a combination thereof. It should be noted that the illustration of the communication line is omitted. The communication interface 106 can play a role of a data acquisition unit that receives input of various data such as the original dataset.

The information processing apparatus 100 includes an input device 122 and a display device. The input device 122 and the display device 124 are connected to the bus 110 via the input/output interface 108. For example, a keyboard, a mouse, a multi-touch panel, other pointing devices, a voice input device, or the like can be applied to the input device 122. The input device 122 may be an appropriate combination of the keyboard and the like described above.

For example, a liquid crystal display, an organic EL display, a projector, or the like is applied to the display device 124. The display device 124 may be an appropriate combination of the above-described liquid crystal display or the like. The input device 122 and the display device 124 may be integrally configured as in the touch panel, or the information processing apparatus 100, the input device 122, and the display device 124 may be integrally configured as in the touch panel type tablet terminal. “Organic EL display” may be referred to as OEL, which is an abbreviation for organic electro-luminescence. Further, EL of “organic EL display” is an abbreviation for electro-luminescence.

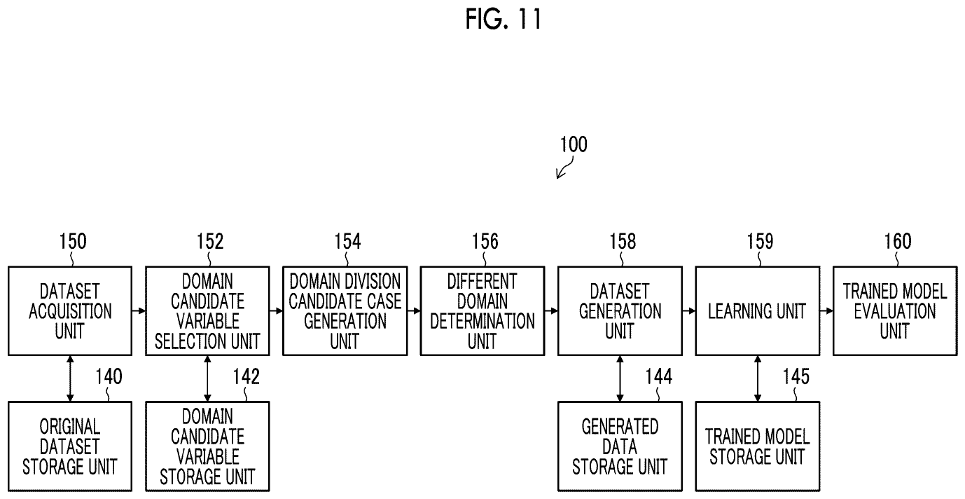

FIG. 11 is a functional block diagram showing a functional configuration of the information processing apparatus shown in FIG. 10. The information processing apparatus 100 comprises a dataset acquisition unit 150, a domain candidate variable selection unit 152, a domain division candidate case generation unit 154, a different-domain determination unit 156, a dataset generation unit 158, a learning unit 159, and a trained model evaluation unit 160.

The dataset acquisition unit 150 acquires a dataset of the behavior history that can be obtained for each item of the plurality of users in one domain that is an original dataset. The original dataset acquired by using the dataset acquisition unit 150 is stored in the original dataset storage unit 140.

The domain candidate variable selection unit 152 selects two or more variables as the domain candidate variables among the plurality of variables excluding the response variable and the explanatory variable among the variables included in the dataset. The domain candidate variable selected by using the domain candidate variable selection unit 152 is stored in the domain candidate variable storage unit 142.

The domain division candidate case generation unit 154 generates a domain division candidate case, which is a candidate case of dividing the dataset, by using the domain candidate variable selected by the domain candidate variable selection unit 152.

The different-domain determination unit 156 determines whether or not the domain division candidate case generated by using the domain division candidate case generation unit 154 is a dataset of different domains.

The dataset generation unit 158 divides the dataset using the variable selected in the domain division candidate case determined by the different-domain determination unit 156 that the domain division candidate case is the dataset of the different domains to generate datasets of a plurality of pseudo domains. The datasets of the plurality of pseudo domains described in the embodiment are examples of divided datasets.

The dataset generation unit 158 may perform processing of correcting the dataset such that only one of the datasets of the plurality of pseudo domains is present for each user. The dataset generation unit 158 may perform processing of correcting the dataset such that only one of the datasets of the plurality of pseudo domains is present for each item. As a result, it is possible to perform learning and evaluation with respect to a large domain shift at a system level.

The learning unit 159 performs learning on the datasets of the plurality of pseudo domains generated by using the dataset generation unit 158 to generate a trained model that is a prediction model of the behavior history of the user. The trained model is stored in the trained model storage unit 145.

The trained model evaluation unit 160 evaluates the trained model generated by using the learning unit 159. The trained model storage unit 145, the learning unit 159, and the trained model evaluation unit 160 may be separated from the information processing apparatus 100.

That is, the information processing apparatus 100 may function as a device that generates datasets of a plurality of pseudo domains. In addition, the device provided with the trained model storage unit 145 and the learning unit 159 may function as a device that generates a trained model. Further, the apparatus comprising the trained model evaluation unit 160 may function as an apparatus that evaluates the trained model.

As the data of the behavior history, the behavior history in the examination result browsing system in the hospital shown in FIG. 9 can be applied. FIG. 9 shows a part of a table of the behavior history data. The item in the behavior history data shown in FIG. 9 is the examination result.

The table shown in FIG. 9 has columns of a user ID, an item ID, a user attribute 1, a user attribute 2, an item attribute 1, an item attribute 2, a context 1, a context 2, and presence or absence of a browsing. In addition, ID is an abbreviation of identification.

A column of time in the table shown in FIG. 9 indicates the date and time when the item is browsed. The user ID is identification information of the user used in a case of specifying the user. FIG. 9 shows an example in which a unique number for each user is applied as the user ID.

The item ID is identification information of the item used in a case of specifying the item. FIG. 9 shows an example in which a unique number for each item is applied as the item ID. For example, the user attribute 1 is applied to the affiliated medical department to which the user belongs. For example, an occupation is applied to the user attribute 2.

For example, the item attribute 1 is applied to the examination type. For example, the item attribute 2 is applied to the gender of the patient. For example, the context 1 is applied to the presence or absence of hospitalization. For example, the context 2 is applied to the elapsed time from the item creation.

The presence or absence of a browse is 1 in a case where the item is browsed. It should be noted that the number of items that are not browsed is enormous, and in general, only in a case where an item of which the presence or absence of a browsing is set to 1 is browsed, the item is recorded in the record.

The presence or absence of a browsing in FIG. 9 is an example of a response variable, and each of an item attribute 1, an item attribute 2, a context 1, and a context 2 is an example of an explanatory variable. In addition, the time, the user ID, the item ID, the user attribute 1, and the user attribute 2 are an example of a plurality of variables from which the response variable and the explanatory variable are excluded.

The type of the explanatory variable and the combination of the explanatory variables are not limited to the example shown in FIG. 9. The explanatory variable may include the user attribute 3, the context 3, and the like. In addition, an aspect in which the context 1 and the context 2 are not included in the explanatory variables may be applied.

### [Procedure of Information Processing Method]

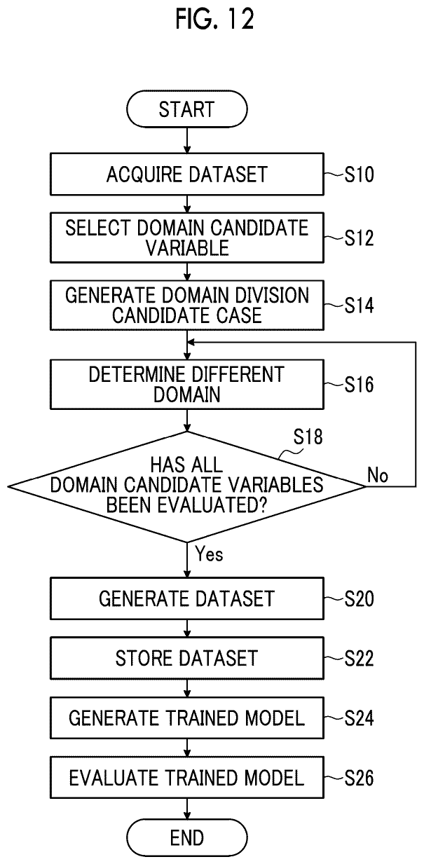

FIG. 12 is a flowchart showing a procedure of the information processing method according to the embodiment. In the dataset acquisition step S10, the dataset acquisition unit 150 shown in FIG. 11 acquires a dataset. The process proceeds to a domain candidate variable selection step S12 after the dataset acquisition step S10.

In the domain candidate variable selection step S12, the domain candidate variable selection unit 152 selects the domain candidate variable from among the variables applied to the dataset acquired in the dataset acquisition step S10. The process proceeds to a domain division candidate case generation step S14 after the domain candidate variable selection step S12.

In the domain division candidate case generation step S14, the domain division candidate case generation unit 154 generates a domain division candidate case in which the dataset acquired by the dataset acquisition unit 150 is divided by using the domain candidate variable selected in the domain candidate variable selection step S12.

In the domain division candidate case generation step S14, a plurality of domain division candidate cases may be generated by using a set of the plurality of domain candidate variables. The process proceeds to the different-domain determination step S16 after the domain division candidate case generation step S14.

In the different-domain determination step S16, the different-domain determination unit 156 determines whether or not the dataset for each domain candidate variable generated in the domain division candidate case generation step S14 is the dataset for each different domain.

In a case where a plurality of domain division candidate cases are generated in the domain division candidate case generation step S14, in the different-domain determination step S16, it is determined whether or not each of the plurality of domain division candidate cases is a dataset for different domains. The process proceeds to a domain division candidate case evaluation determination S18 after the different-domain determination step S16.

In the domain division candidate case evaluation determination S18, in a case in which it is determined that the determination result for all the domain division candidate cases is not obtained, the different-domain determination unit 156 makes a No determination. In a case where the No determination is made, the process returns to the different-domain determination step S16, and the different-domain determination step S16 and the domain division candidate case evaluation determination S18 are repeatedly executed until a Yes determination is made in the domain division candidate case evaluation determination S18.

On the other hand, in the domain division candidate case evaluation determination S18, in a case in which it is determined that the determination result for all the domain division candidate cases is obtained, the different-domain determination unit 156 makes a Yes determination. In a case where the Yes determination is made, the process proceeds to a dataset generation step S20.

In the dataset generation step S20, the dataset is divided by using the domain candidate variable applied to the domain division candidate case which is determined to be the dataset for each of the different domains in the domain division candidate case evaluation determination S18, and a plurality of datasets that can be regarded as the datasets in each of the plurality of pseudo domains are generated. The process proceeds to a dataset storage step S22 after the dataset generation step S20.

In the dataset storage step S22, the dataset generation unit 158 stores the plurality of datasets generated in the generated data storage unit 144. After the dataset storage step S22, the process proceeds to a trained model generation step S24.

In the trained model generation step S24, the learning unit 159 performs learning using the dataset generated by the dataset generation unit 158 to generate a trained learning model. The trained model generated in the trained model generation step S24 is stored in the trained model storage unit 145. After the trained model generation step S24, the process proceeds to a trained model evaluation step S26.

In the trained model evaluation step S26, the trained model evaluation unit 160 evaluates the performance of the trained model generated in the trained model generation step S24. The trained model evaluated to satisfy the defined performance in the trained model evaluation step S26 is introduced into a domain different from the domain from which the original dataset is acquired. After the trained model evaluation step S26, the information processing apparatus 100 ends the procedure of the information processing method.

The trained model generation step S24 may be executed as a trained model manufacturing method by a trained model generation apparatus different from the information processing apparatus 100. Similarly, the trained model evaluation step S26 may be executed as a trained model evaluation method in a trained model evaluation apparatus different from the information processing apparatus 100 and the trained model generation apparatus. [Specific Example of Information Processing Method]

A specific example of the information processing method shown in FIG. 12 will be described. For example, a case where the original dataset is the behavior history in the examination result browsing system in the hospital shown in FIG. 9 will be considered.

The suggestion model generated by executing the learning using the dataset uses the item attribute 1, the item characteristic 2, the context 1, and the context 2 as explanatory variables. In addition, the suggestion model predicts the presence or absence of a browse of the item, which is the behavior of the user, using the presence or absence of a browsing of the item as the response variable. In a case of operating as a suggestion system, the browsing rate for all items of the candidates is predicted using the trained suggestion model, and five items having the highest browsing rates are selected and suggested.

In the behavior history in the examination result browsing system shown in FIG. 9, there are time, a user ID, a user attribute 1, and a user attribute 2 as a plurality of variables from which the response variable and the explanatory variable are excluded. In the division of the dataset, any one of the plurality of variables from which the response variable and the explanatory variable are excluded is used as the domain candidate variable.

Hereinafter, an example in which the user attribute 1 to which the affiliated medical department is applied and the user attribute 2 to which the occupation is applied are used as the domain candidate variable will be described. First, the user attribute 1 is applied to the domain candidate variable to divide the original dataset.

For example, a dataset of a respiratory medicine department is referred to as a dataset 1A, and a dataset of a gastroenterology department is referred to as a dataset 1B. It is assumed that learning is performed using the dataset 1A, the browsing prediction is performed in a range of the dataset 1A, and an indicator of hit@5, which represents a probability that one of five suggestions is correct, is 34%. In addition, the browsing prediction is performed in the range of the dataset 1B, and the indicator of hit@5 is 32 percent. A deterioration rate of prediction performance in such a case is 2%.

On the other hand, it is assumed that, for the trained model generated by being trained using the dataset 1B, the deterioration rate of the prediction performance, which is the difference between the indicator of hit@5 of the prediction performed in the range of the dataset 1A and the indicator of hit@5 of the prediction performed in the range of the dataset 1B, is 1%. An average of the deterioration rates of prediction performance of the trained model generated by being trained using the dataset 1A and the deterioration rates of prediction performance of the trained model generated by performing the learning by using the dataset 1B is 1.5 percent.

Next, the user attribute 2 to which the occupation is applied is applied to the domain candidate variable to divide the original dataset. A dataset of a doctor is referred to as a dataset 2A, and a dataset of a nurse is referred to as a dataset 2B.

In a case where the trained model generated by using the dataset 2A is evaluated in the range of the dataset 2A, the indicator of hit@5 is 32%. In a case where the trained model generated by using the dataset 2A is evaluated in the range of the dataset 2B, the indicator of hit@5 is 21%. The deterioration rate of prediction performance is 11%.

It is assumed that the difference between the index of hit@5 in a case of evaluation in the range of the dataset 2A and the index of hit@5 in a case of evaluation in the range of the dataset 2B for the trained model generated by using the dataset 2B is 9%. The average of the deterioration rate of prediction performance is 10%.

In a case where the dataset is divided by using the user attribute 1 as the domain candidate variable, the deterioration rate of prediction performance is significantly large in a case where the dataset is divided by using the user attribute 2 as the domain candidate variable. Therefore, in a case where the dataset is divided by using the user attribute 2 as the domain candidate variable, it is determined to be suitable for division of different domains. Based on such a determination result, the dataset 2 is divided by using the user attribute 2, and datasets of a plurality of pseudo domains are generated.

Next, learning is performed using the generated dataset, and a trained model is generated. In addition, the trained model is evaluated. In a case where there are a plurality of model candidates, it is preferable to evaluate the model candidates before operating the suggestion system and select the optimal model.

As a model candidate, three models of logistic regression, factorization machines, and gradient boosting decision trees are considered. Further, each model has a hyperparameter in a case of learning. Examples of a hyperparameter in the logistic regression include a regularization coefficient.

Examples of the hyperparameter in the factorization machines include a regularization coefficient and the number of latent dimensions. Examples of the hyperparameter in the gradient boosting decision tree include a tree depth and a number of trees. Here, it is assumed that a random grid search is performed in which 20 pieces of combinations of hyperparameters are randomly selected for each model and the optimal hyperparameters are searched.

Next, the learning of 60 models for each of the three models and each of the 20 hyperparameters is performed using the dataset 2A in which the user attribute 2 is the doctor. Further, the performance evaluation of the trained model is performed by using the dataset 2B in which the user attribute 2 is the nurse.

In the performance evaluation of the trained model to which the dataset 2B is applied, it is considered that the trained model having the highest performance evaluation is a trained model having the highest performance as data of a domain different from the training data and having the highest domain generalization.

Here, in a case where the performance evaluation result using the dataset 2B is the highest in factorization machines in a case where the regularization coefficient is 0.001 and the number of latent dimensions is 50, factorization machines are adopted as the model, and the regularization coefficient and the number of latent dimensions are adopted as the hyperparameters.

In this way, in a case where an examination result viewing suggestion system that suggests an examination result to be viewed next to a user, such as a doctor, is introduced into another facility, such as another hospital, the trained model described above is suggested. [Specific Example of Generation of Dataset]

FIG. 13 is a schematic diagram of generation of a dataset using a domain candidate variable. FIG. 13 schematically shows the processing of the domain division candidate case generation step S14 and the processing of the different-domain determination step S16 shown in FIG. 12.

FIG. 13 schematically shows processing of generating a domain division candidate case in which an original dataset 300 is divided into two using a domain candidate variable 302 to generate a dataset 304 and a dataset 306.

Here, the domain is a dataset consisting of the explanatory variable X and the response variable Y generated from a certain probability distribution P(X,Y). In a case where domains different from each other are denoted by d1 and d2, and a relationship between a probability distribution Pd1(X,Y) in the domain d1 and a probability distribution Pd2(X,Y) in the domain d2 is Pd1(X,Y)≠Pd2(X,Y), the domain d1 and the domain d2 are different domains.

It is difficult to strictly estimate the probability distribution P(X,Y) from the finite dataset. In addition, a calculation of the number of combinations is required for the method of assigning the domain d1 and the domain 2d. Therefore, it is necessary to make some contrivance in determining the difference between Pd1(X,Y) and Pd2(X,Y).

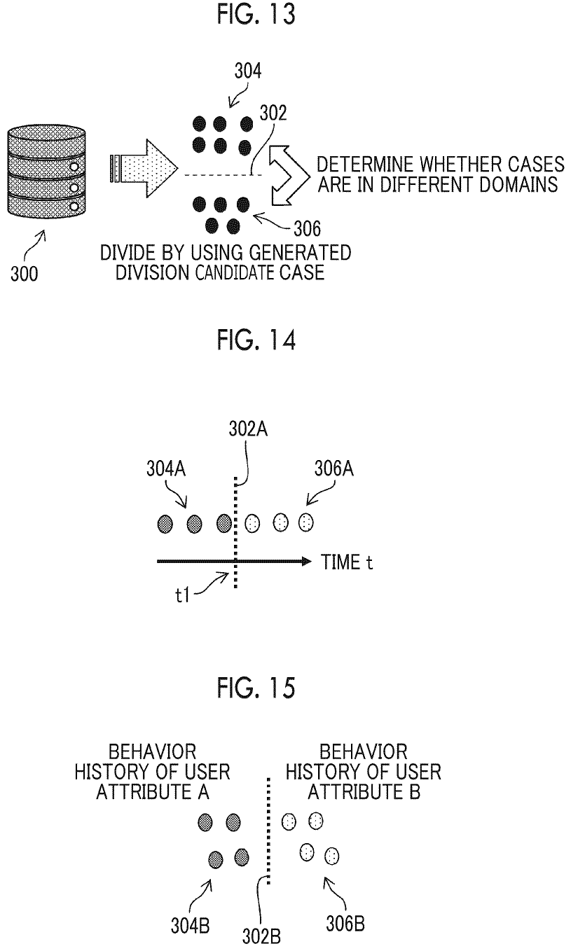

FIG. 14 is a schematic diagram showing an example of domain division candidate case generation applied to the generation of the dataset shown in FIG. 13. FIG. 14 shows, in a case where the data of the behavior history shown in FIG. 9 is used as the dataset 300, an example of dividing the dataset 300 using a domain candidate variable 302A representing the time series. FIG. 14 shows an example of a case where the datasets are divided into two in the dataset 304A before the time point t1 and the dataset 306A after the time point t1.

FIG. 15 is a schematic diagram showing another example of the domain division candidate case generation applied to the generation of the dataset shown in FIG. 13. In a case where the data of the behavior history shown in FIG. 9 is used as the dataset 300, an example of dividing the dataset 300 using the user attribute as the domain candidate variable 302B is shown.

For example, an example of dividing the dataset into any of the user attribute 1 to which the affiliated medical department shown in FIG. 9 is applied or the user attribute 2 to which the occupation is applied is shown. In a case where the affiliated medical department is applied as the user attribute, the behavior history of the user attribute A in FIG. 15 is a dataset 304B in which a user whose occupation is a respiratory medicine department has browsed the examination result browsing system, and the behavior history of the user attribute B is a dataset 306B in which a user whose occupation is a gastroenterology department has browsed the examination result browsing system.

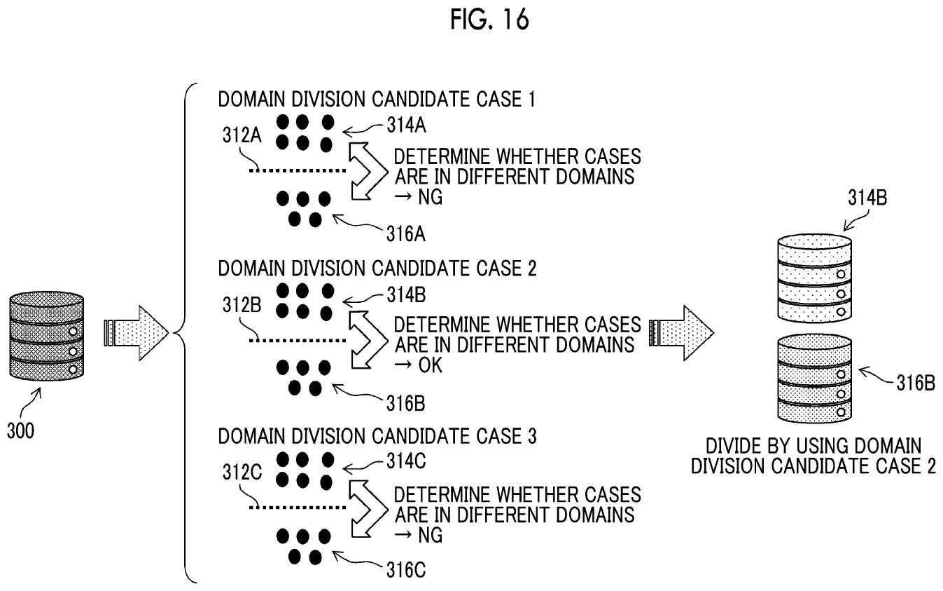

FIG. 16 is a schematic diagram of generation of a dataset in a case where a plurality of domain candidate variables are selected. FIG. 16 shows an example of a case where the domain candidate variable 312A, the domain candidate variable 312B, and the domain candidate variable 312C are selected, and the domain division candidate case 1, the domain division candidate case 2, and the domain division candidate case 3 are generated.

The domain division candidate case 1 shown in FIG. 16 is a domain division candidate case in which the dataset 300 is divided into a dataset 314A and a dataset 316A by using the domain candidate variable 312A.

The domain division candidate case 2 is a domain division candidate case in which the dataset 300 is divided into a dataset 314B and a dataset 316B by using the domain candidate variable 312B. The domain division candidate case 3 is a domain division candidate case in which the dataset 300 is divided into a dataset 314C and a dataset 316C by using the domain candidate variable 312C.

In the example shown in FIG. 16, the domain division candidate case 2 is determined to be a dataset for different domains. On the other hand, it is determined that neither the domain division candidate case 1 nor the domain division candidate case 3 is a dataset for each different domain. The domain division candidate case 2 is adopted, and the dataset 314B and the dataset 316B are generated from the dataset 300.

### [Specific Example of Generation of Domain Division Candidate Case]

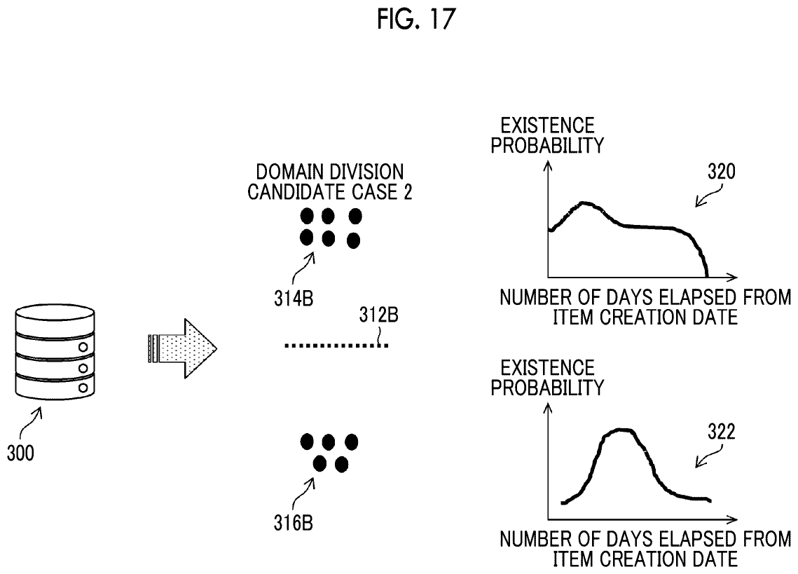

FIG. 17 is a schematic diagram showing an example of the generation of the domain division candidate case. FIG. 17 shows an example of generation of a domain division candidate case in a case where the domain division candidate case 2 shown in FIG. 16 is adopted. A graph 320 and a graph 322 shown in FIG. 17 are graphs in which the number of days elapsed from the item creation, which is the explanatory variable in the prediction model, is set as a horizontal axis, and the data existence probability P(X,Y) is set as a vertical axis. The graph 320 shown in FIG. 17 corresponds to the dataset 314B shown in FIG. 16. In addition, the graph 322 corresponds to the dataset 316B.

The number of days elapsed from the item creation date, which is the domain candidate variable serving as the horizontal axis of the graph 320 and the graph 322, is a feature amount universal in the domain. The number of days elapsed from the item creation date is suitable for the explanatory variable of the prediction model.

In order to appropriately learn the influence of the number of days elapsed from the item creation date on the browsing, it is preferable that the dataset 314B and the dataset 316B generated from the dataset 300 include data for each explanatory variable.

That is, there is a certain overlap between the graph 320 representing the existence probability of the data for each explanatory variable in the dataset 314B and the corresponding graph 322 representing the existence probability of the data for each explanatory variable in the dataset 316B.

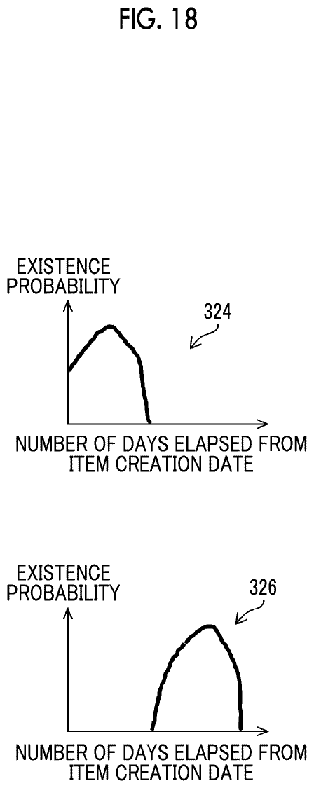

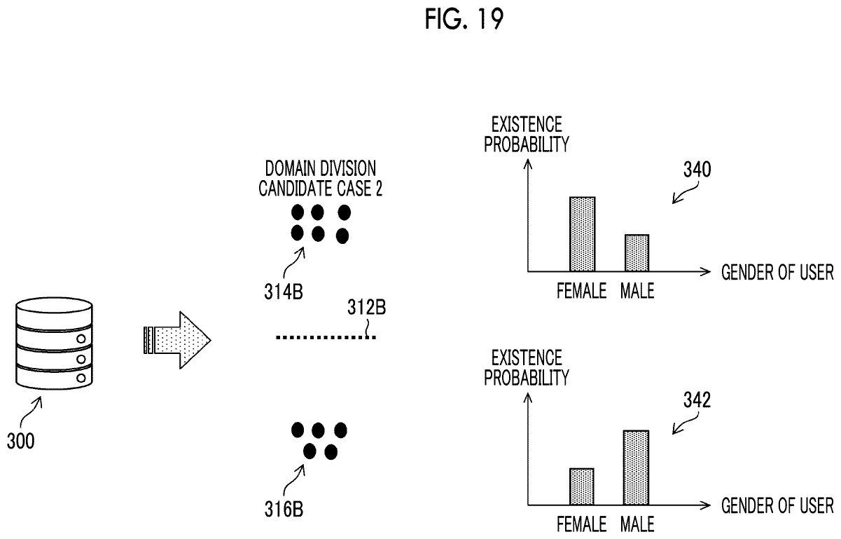

FIG. 18 is a schematic diagram showing another example of the generation of the domain division candidate case. Similar to the graph 320 and the like shown in FIG. 17, the graph 324 and the graph 326 shown in FIG. 18 are graphs in which the number of days elapsed from the creation of the item is the horizontal axis and the existence probability P(X,Y) of the presence of the data is the vertical axis. For example, a graph 324 shown in FIG. 18 corresponds to the dataset 314A generated in the division candidate case 1 shown in FIG. 16, and a graph 326 corresponds to the dataset 316B.

There is no constant overlap between the graph 324 representing the existence probability of the data for each explanatory variable in the dataset 314A and the corresponding graph 326 representing the existence probability of the data for each explanatory variable in the dataset 316A. In this case, the domain candidate variable in the generation of the dataset 314A and the dataset 316A is not suitable for generating a domain division case.

FIG. 19 is a schematic diagram showing the generation of domain division candidate cases in a case where the explanatory variables are different from the explanatory variables shown in FIG. 17. A graph 340 and a graph 342 shown in FIG. 19 are graphs showing the distribution of the data existence probability with respect to the explanatory variable in a case in which the gender of the user is applied as the explanatory variable.

The gender of the user is a feature amount universal in the domain and is used as an explanatory variable in the prediction model. Both the graph 340 corresponding to the dataset 314B and the graph 342 corresponding to the dataset 316B have data of males and data of females, and there is a certain degree of overlap between the data of males and the data of females.

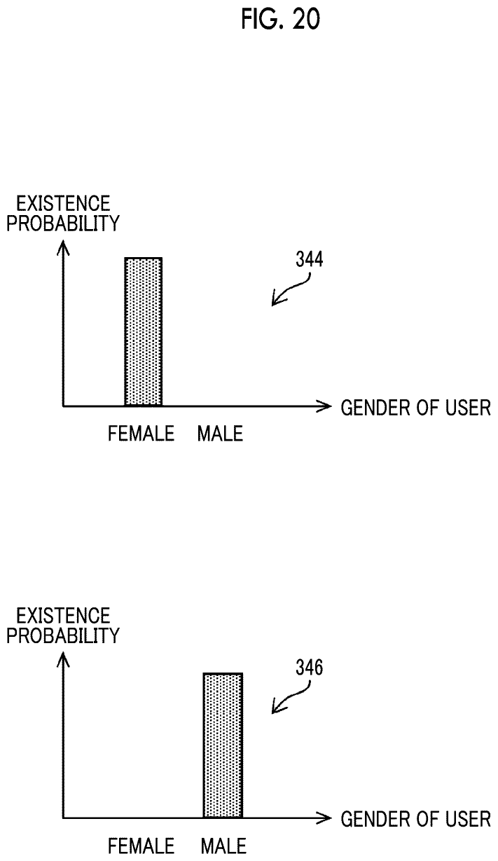

FIG. 20 is a schematic diagram showing the generation of the domain division candidate case in a case where the explanatory variables are different from the explanatory variables shown in FIG. 18. FIG. 20 shows, as in FIG. 19, a graph 344 and a graph 346 to which the gender of the user, which is the explanatory variable in the prediction model, is applied, and the vertical axis is the data existence probability P(X,Y) for each gender of the user.

Only the data of females is present in the graph 344, and the data of males is not present. On the other hand, the graph 346 does not include the data of females and includes only the data of males. The graph 344 and the graph 346 do not overlap with each other, and it is difficult to learn how the gender of the user affects the behavior of the user such as browsing in each dataset.

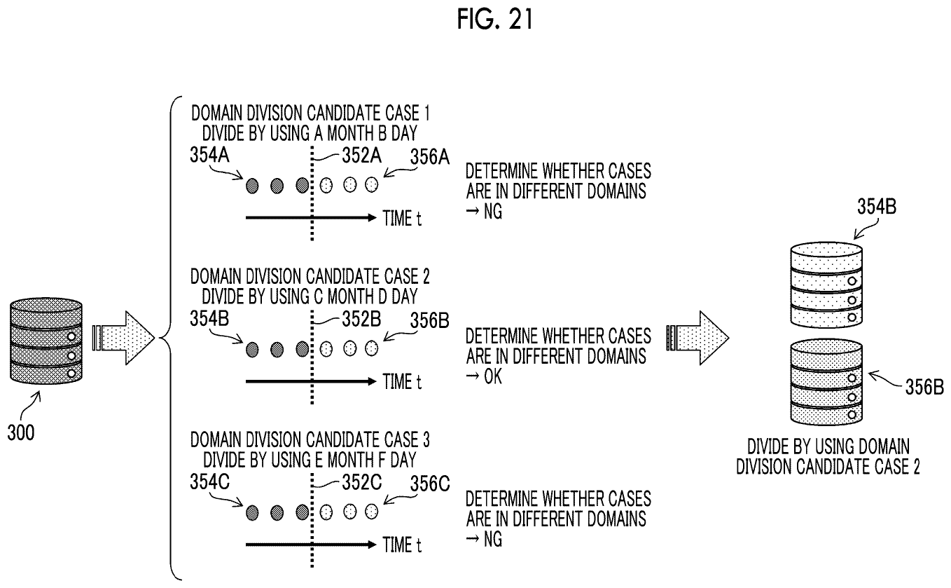

FIG. 21 is a schematic diagram of generation of a domain division candidate case to which time is applied as a domain candidate variable. FIG. 21 shows a further specific example of the example shown in FIG. 14. As the domain division candidate case 1, an example in which a dataset 354A of a date before an A month B day and a dataset 356A of a date after the A month B day are generated by using the domain candidate variable 352A to which the date is applied is shown.

In addition, FIG. 21 shows an example in which a dataset 354B of a date before a C month D day and a dataset 356B of a date after the C month D day are generated using the domain candidate variable 352B to which the date is applied as the domain division candidate case 2.

Further, FIG. 21 shows an example in which a dataset 354C of a date before an E month F day and a dataset 356B of a date after the E month F day are generated by using the domain candidate variable 352C to which the date is applied as the domain division candidate case 3. It should be noted that, the A month B day, the C month D day, and the E month F day indicate any different dates.

In the example shown in FIG. 21, the domain division candidate case 2 is adopted, and the dataset 354B of a date before the C month D day and the dataset 356B of a date after the C month D day are generated from the dataset 300.

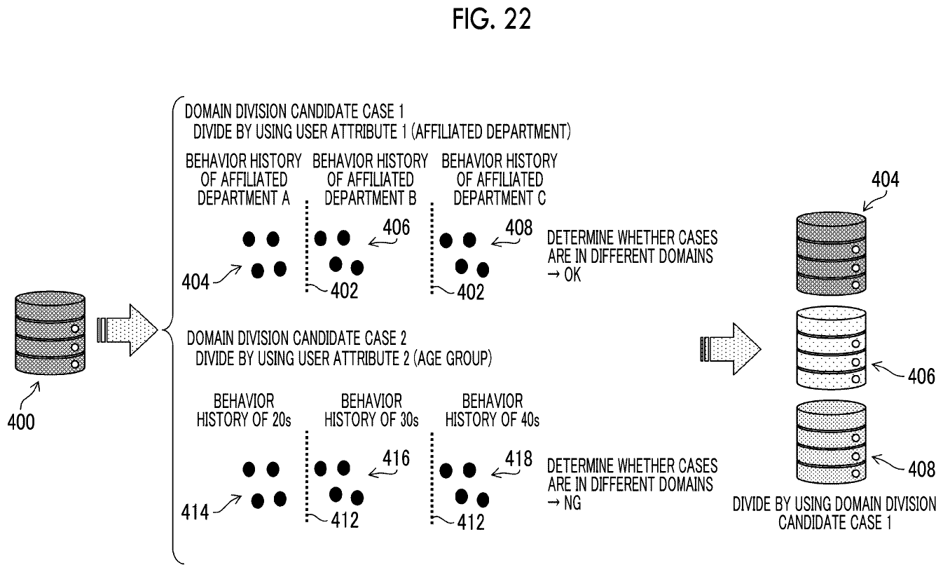

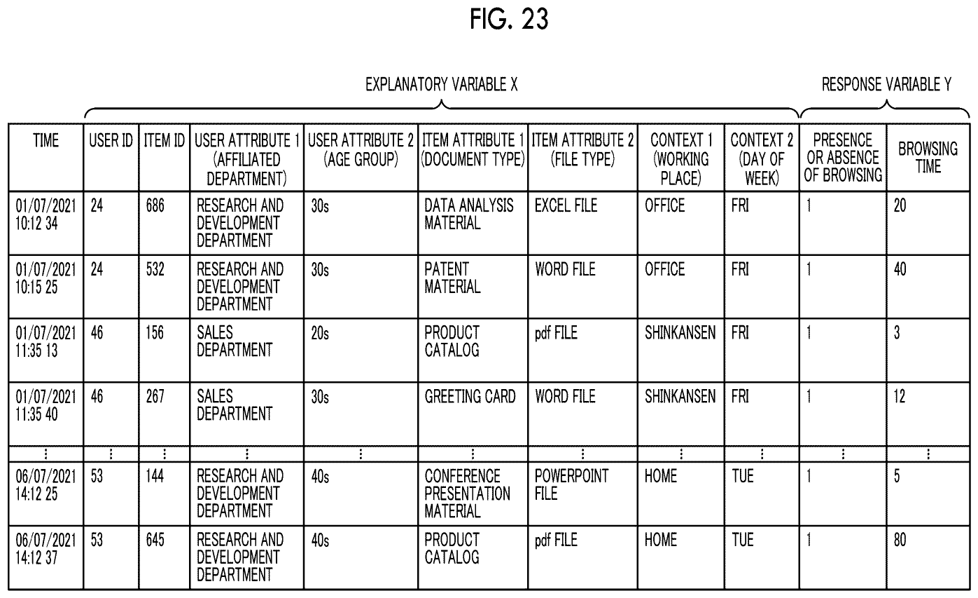

FIG. 22 is a schematic diagram of generation of a domain division candidate case to which the user attribute is applied as the domain candidate variable. FIG. 23 is a table showing an example of the dataset shown in FIG. 22. FIG. 23 shows a part of a table of data of the behavior history related to the browsing of the document obtained from the document information management system of a certain company. FIG. 22 shows still another specific example of the example shown in FIG. 15.

As a domain division candidate case 1, an example in which a dataset 404, a dataset 406, and a dataset 408 are generated from a dataset 400 using a domain candidate variable 402 to which the affiliated department is applied is shown.

In addition, FIG. 22 shows an example in which a dataset 414, a dataset 416, and a dataset 418 are generated from the dataset 400 using the domain candidate variable 412 to which the age is applied as the domain division candidate case 2.

In the example shown in FIG. 21, the domain division candidate case 1 is adopted, and the dataset 404 of the affiliated department A, the dataset 406 of the affiliated department B, and the dataset 408 of the affiliated department C are generated from the dataset 400.

In FIG. 9, the item attribute 1, the item attribute 2, the context 1, and the context 2 are shown as the explanatory variables X, but in a case where these variables are not used as the explanatory variables of the prediction model, these variables may be used as the domain candidate variables.

That is, the original dataset may be divided into a plurality of datasets using the item attribute 1 and the item attribute 2 that are not used as the explanatory variables of the prediction model to generate the plurality of datasets. For example, in the dataset of the behavior history in the examination result browsing system shown in FIG. 9, a dataset corresponding to CT, a dataset corresponding to X-rays, a dataset corresponding to ultrasound, and a dataset corresponding to PCR may be generated by using the examination type as the domain candidate variable. Note that, CT is an abbreviation for computed tomography. PCR is an abbreviation for polymerase chain reaction.

In addition, a dataset corresponding to a male patient and a dataset corresponding to a female patient may be generated by using the item attribute 2 to which the patient gender shown in FIG. 9 is applied as a domain candidate variable.

A dataset corresponding to an outpatient and a dataset corresponding to an inpatient may be generated by using the context 1 to which the presence or absence of hospitalization shown in FIG. 9 is applied as a domain candidate variable. In addition, a dataset before a certain elapsed time and a dataset after the certain elapsed time may be generated by using, as the domain candidate variable, a context 2 to which the elapsed time from the item creation date is applied. A variable that is not used as the explanatory variable described in the embodiment is an example of a variable that is not applied to the explanatory variable.

### [Specific Example of Determination of Different Domains]

### [Determination Using Deterioration Rate of Prediction Performance]

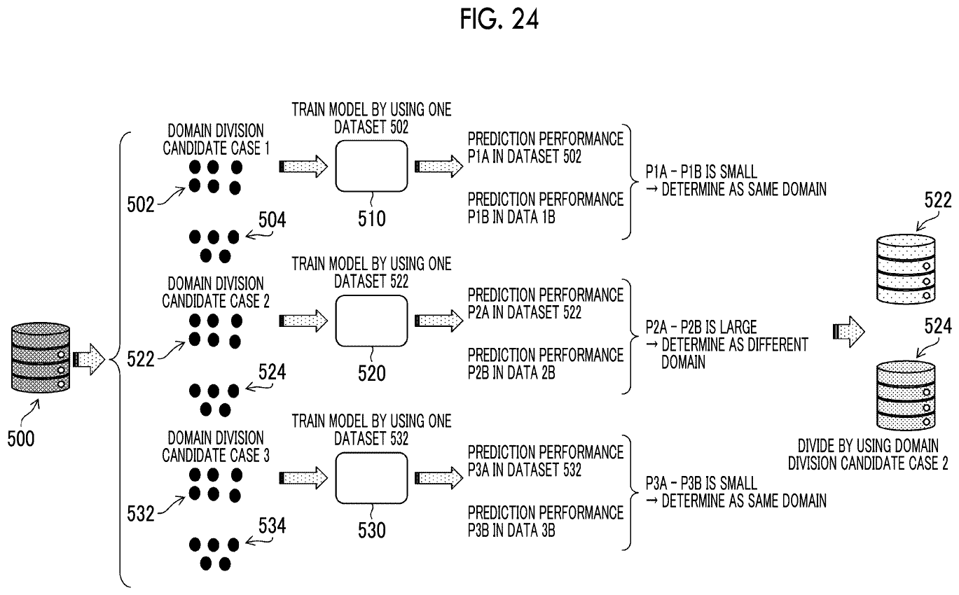

FIG. 24 is a schematic diagram showing a specific example of the determination of different domains. FIG. 24 shows an example in which two datasets are generated in each domain division candidate case, a trained model is generated by using one dataset, and whether or not the two datasets are datasets of different domains is determined based on a deterioration rate of prediction performance in a range of one dataset with respect to prediction performance in a range of the other dataset.

As a domain division candidate case 1, a dataset 502 and a dataset 504 are generated from a dataset 500. The learning is performed using the dataset 502, and a trained model 510 is generated. It should be noted that the learning may be performed using the dataset 504 to generate the trained model.

Using the trained model 510, the prediction performance is evaluated in the range of the dataset 502, and the prediction performance PIA is derived. Using the trained model 510, the prediction performance is evaluated in the range of the dataset 504, and the prediction performance P1B is derived. Specifically, P1A−P1B obtained by subtracting the prediction performance P1B from the prediction performance PIA is calculated as a deterioration factor of the prediction performance.

As a domain division candidate case 2, a dataset 522 and a dataset 524 are generated from the dataset 500, and a trained model 520 is generated by using a dataset 522 or a dataset 524. The prediction performance P2A in the range of the dataset 522 and the prediction performance P2B in the range of the dataset 524 are derived, and P2A−P2B is calculated as a deterioration factor of the prediction performance.

As a domain division candidate case 3, a dataset 532 and a dataset 534 are generated from the dataset 500, and a trained model 530 is generated by using a dataset 532 or a dataset 534. The prediction performance P3A in the range of the dataset 532 and the prediction performance P3B in the range of the dataset 534 are derived, and P3A−P3B is calculated as a deterioration factor of the prediction performance.

The domain division candidate case to be adopted is determined based on the magnitudes |P1A−P1B| of the deterioration factor of prediction performance in the domain division candidate case 1, the magnitudes |P2A−P2B| of the deterioration factor of prediction performance in the domain division candidate case 2, and the magnitudes |P3A−P3B| of the deterioration factor of prediction performance in the domain division candidate case 3.

In the example shown in FIG. 24, the domain division candidate case 2 is adopted, and the dataset 522 and the dataset 524 are generated from the dataset 500. The prediction performance of the trained model depends on the amount of training data applied to the learning. In a case of generating the trained model, the amount of training data is adjusted or the training data amount dependence is corrected.

The deterioration rate of prediction performance and the deterioration factor of the prediction performance described in the embodiment are an example of a performance difference of the prediction model. In addition, one dataset in each domain division candidate case is an example of a first dataset candidate, and the other dataset is an example of a second dataset candidate.

[Determination Using Difference in Probability Distribution]

The determination of the different domains may be performed using a difference in probability distribution for each domain candidate variable. For example, in the determination of the different domains, a Kullback-Leibler divergence in the probability distribution for each domain candidate variable may be used. Note that, “Kullback-Leibler divergence” may be referred to as the Kullback-Leibler divergence using English notation.

In a case where the probability distribution of the domain d1 is represented by Pd1(X), the probability distribution of the domain d2 is represented by Pd2(X), and k is a discrete variable that X can take, the Kullback-Leibler divergence is represented by Expression 1.

$${Σ}_{k} Pd 1 ( x = k ) ( log ( Pd 2 ( x = k ) - log ( Pd 2 ( x = k ) ) \qquad Expression 1$$

The domain d1 referred to here is one of the domain candidate variables, and the domain d2 is one of the domain candidate variables different from the domain candidate variable set as the domain d1.

In addition, an optimal transport distance may be applied as an indicator representing a difference in the probability distribution applied to the determination of the different domains. The optimal transport distance is represented by Expression 2.

$$min {\sum }_{i} {{π}_{i , j} ( {‖ {x}_{i} - {x}_{j} ‖}_{p} )}^{1 / p} \qquad Expression 2$$

Here, Xᵢ in Expression 2 is the data of the domain d1, and Xⱼ in Expression 2 is the data of the domain d2.

### Effects of Embodiment

The information processing apparatus and the information processing method according to the embodiment can obtain the following effects.

[1]

A domain candidate variable is selected from a plurality of variables excluding a response variable and an explanatory variable in a prediction model, a domain division candidate case that divides an original dataset by using the domain candidate variable is generated, it is determined whether or not each of the domain division candidate cases is appropriate, the original dataset is divided by using the domain candidate variable determined to be appropriate as a dataset of a different domain, and datasets of a plurality of pseudo domains are generated.

Accordingly, the number of domains in the training data can be increased, and the number of domains used for the learning and the evaluation of the trained model can be increased.

[2]

In a case where the original dataset is divided by using the domain candidate variable, the probability distribution of the explanatory variable applied to the trained model has a constant overlap in the divided dataset. Accordingly, data of the explanatory variable common to the divided datasets may be present.

[3]

Any one of time, a user attribute that is not used as the explanatory variable, an item attribute that is not used as the explanatory variable, or a context that is not used as the explanatory variable is applied to the domain candidate variable. As a result, it is possible to suitably divide the original dataset, which is suitable for generating datasets of a plurality of pseudo domains.

[4]

In the determination of the different domains, an index indicating a difference in the probability distribution in the dataset for each domain candidate variable is derived, and the index is applied to the determination. The dataset having a difference in probability distribution is suitable as a dataset of different domains.

[5]

In the determination of the different domains, the trained model is generated by using any of the plurality of datasets for each domain division candidate, the performance evaluation of the trained model is performed in each range of the plurality of datasets, a deterioration factor of performance is derived, and the deterioration factor of performance is used for the determination.

The dataset having the deterioration factor of performance is suitable as a dataset of different domains.

[6]

In the plurality of datasets generated by dividing the original dataset, correction is made such that any one of the users is present in only one dataset. As a result, it is possible to perform learning and performance evaluation with respect to a large domain shift at a system level, such as another facility.

[7]

In the plurality of datasets generated by dividing the original dataset, correction is made such that any one of the items is present in only one dataset. As a result, it is possible to perform learning and performance evaluation with respect to a large domain shift at a system level, such as another facility.

The technical scope of the present invention is not limited to the scope described in the above-described embodiment. The configurations and the like in each embodiment can be appropriately combined between the respective embodiments without departing from the spirit of the present invention.

### EXPLANATION OF REFERENCES

10: suggestion system
12: prediction model
14: model
100: information processing apparatus
102: processor
104: computer-readable medium
106: communication interface
108: input/output interface
110: bus
112: memory
114: storage
122: input device
124: display device
130: domain candidate variable selection program
132: dataset candidate generation program
134: dataset determination program
136: dataset generation program
138: learning program
139: trained model evaluation program
140: original dataset storage unit
142: domain candidate variable storage unit
144: generated data storage unit
145: trained model storage unit
150: dataset acquisition unit
152: domain candidate variable selection unit
154: domain division candidate case generation unit
156: different-domain determination unit
158: dataset generation unit
159: learning unit
160: trained model evaluation unit
300: dataset
302: domain candidate variable
302A: domain candidate variable
302B: domain candidate variable
304: dataset
304A: dataset
304B: dataset
306: dataset
306A: dataset
306B: dataset
312A: domain candidate variable
312B: domain candidate variable
312C: domain candidate variable
314A: dataset
314B: dataset
314C: dataset
316A: dataset
316B: dataset
316C: dataset
320: graph
322: graph
324: graph
326: graph
340: graph
342: graph
344: graph
346: graph
352A: domain candidate variable
352B: domain candidate variable
352C: domain candidate variable
354A: dataset
354B: dataset
354C: dataset
356A: dataset
356B: dataset
400: dataset
402: domain candidate variable
404: dataset
406: dataset
408: dataset
412: domain candidate variable
414: dataset
416: dataset
418: dataset
500: dataset
510: trained model
520: trained model
522: dataset
524: dataset
530: trained model
532: dataset
534: dataset
IT1: item
IT2: item
IT3: item
S10 to S26: each step of information processing method

What is claimed is:

1. An information processing method of generating a dataset applied to construction of a prediction model using a response variable and one or more explanatory variables, with user behavior as the response variable, for a dataset consisting of a behavior history with respect to a plurality of items of a plurality of the users, the information processing method comprising:
acquiring a dataset in one domain, the dataset being a dataset in which the response variable, the explanatory variable, and a plurality of variables excluding the response variable and the explanatory variable are applied;
selecting a plurality of domain candidate variables that are domain candidates from the plurality of variables excluding the response variable and the explanatory variable;
generating a dataset candidate for dividing the dataset by using the domain candidate variables;
determining whether or not each dataset candidate is a dataset in a different domain; and
generating, in a case where each dataset candidate is a dataset in a different domain, a divided dataset by dividing the dataset for each of domains using the domain candidate variables as domains.

2. The information processing method according to claim 1,
wherein the dataset candidate with which at least a part of a distribution of an existence probability of data for each of the explanatory variables overlaps is generated.

3. The information processing method according to claim 1,
wherein time is applied as the domain candidate variable to generate the dataset candidate.

4. The information processing method according to claim 1,
wherein a user attribute, which is not applied to the explanatory variable, is applied as the domain candidate variable to generate the dataset candidate.

5. The information processing method according to claim 1,
wherein an item attribute, which is not applied to the explanatory variable, is applied as the domain candidate variable to generate the dataset candidate.

6. The information processing method according to claim 1,
wherein a context, which is not applied to the explanatory variable, is applied as the domain candidate variable to generate the dataset candidate.

7. The information processing method according to claim 1,
wherein whether or not the dataset candidate is a dataset in a different domain is determined based on one or more differences in probability distribution between the explanatory variables and the response variables.

8. The information processing method according to claim 1,
wherein a trained model generated by being trained using any of a plurality of the dataset candidates is generated,
among the plurality of dataset candidates,
performance of the trained model is evaluated in a range of a first dataset candidate, performance of the trained model is evaluated in a range of a second dataset candidate different from the first dataset candidate, and
whether or not the dataset candidates are in different domains is determined based on a performance difference between performance of the trained model corresponding to the first dataset candidate and performance of the trained model corresponding to the second dataset candidate.

9. The information processing method according to claim 1,
wherein processing of causing each user or each item to exist in only one of the divided datasets is performed on the divided dataset.

10. An information processing apparatus that generates a dataset applied to construction of a prediction model using a response variable and one or more explanatory variables, with user behavior as the response variable, for a dataset consisting of a behavior history with respect to a plurality of items of a plurality of the users, the information processing apparatus comprising:
one or more processors; and
one or more memories in which a program executed by the one or more processors is stored,
wherein the one or more processors are configured to execute a command of the program to:
acquire a dataset in one domain, the dataset being a dataset in which the response variable, the explanatory variable, and a plurality of variables excluding the response variable and the explanatory variable are applied;
select a plurality of domain candidate variables that are domain candidates from the plurality of variables excluding the response variable and the explanatory variable;
generate a dataset candidate that divides the dataset by using the domain candidate variables;
determine whether or not each dataset candidate is a dataset in a different domain; and
in a case where each dataset candidate is a dataset in a different domain, generate a divided dataset by dividing the dataset for each of domains using the domain candidate variables as domains.

11. A non-transitory, computer-readable tangible recording medium on which a program for causing, when read by a computer, the computer to realize functions comprising:
acquiring a dataset in one domain, the dataset being a dataset in which the response variable, the explanatory variable, and a plurality of variables excluding the response variable and the explanatory variable are applied;
selecting a plurality of domain candidate variables that are domain candidates from the plurality of variables excluding the response variable and the explanatory variable;
generating a dataset candidate for dividing the dataset by using the domain candidate variables;
determining whether or not each dataset candidate is a dataset in a different domain; and
generating, in a case where each dataset candidate is a dataset in a different domain, a divided dataset by dividing the dataset for each of domains using the domain candidate variables as domains.
